(19) United States
(12) Patent Application Publication
(10) Pub. No.: US 2020/0162120 A1
(43) Pub. Date: May 21, 2020

(54) TABLET COMPUTER CASE

(71) Applicant: Griffin Technology, LLC, Irvine, CA (US)

(72) Inventors: Daniel Poon, Nashville, TN (US); Tony Ray Plunk, Fairview, TN (US)

(73) Assignee: Griffin Technology, LLC, Irvine, CA (US)

(21) Appl. No.: 16/687,686

(22) Filed: Nov. 18, 2019

Related U.S. Application Data
(63) Continuation-in-part of application No. 16/182,940, filed on Nov. 7, 2018, now Pat. No. 10,484,034.
Application No. 16/182,940 is a continuation of application No. 15/809,859, filed on Nov. 10, 2017, now Pat. No. 10,128,888.
Application No. 15/809,859 is a continuation of application No. 15/392,303, filed on Dec. 28, 2016, now Pat. No. 9,838,063.
Application No. 15/392,303 is a continuation of application No. 15/095,711, filed on Apr. 11, 2016, now Pat. No. 9,571,149.
(60) Provisional application No. 62/145,064, filed on Apr. 9, 2015.

(51) Int. Cl. H04B 1/3877; H04B 1/3888; A45C 11/00

(52) U.S. Cl. CPC H04B 1/3877; H04B 1/3888; A45C 2011/003; A45C 2200/15; A45C 2011/002; A45C 11/00

(57) ABSTRACT

A case for a portable electronic device that includes a device stand attached to a back surface of the case housing is disclosed herein. The device stand is formed by an inner stand and an outer stand connected by releasable hinged connections that are connected to the back surface of the case housing. One or more tracks are formed on an inner surface of the outer stand. The inner stand slides along the one or more tracks. A locking portion such as a cavity or channel on the outer stand locks the inner stand into an open position with respect to the outer stand. At least a portion of the outer stand is flexible such that applying a threshold pressure to the case causes the portion of the outer stand to flex, releasing the inner stand from the locking portion to allow the inner and outer stands to be closed.

### CROSS-REFERENCE TO RELATED APPLICATIONS

This application is a continuation-in-part of U.S. patent application Ser. No. 16/182,940, filed on Nov. 7, 2018, which is a continuation of U.S. patent application Ser. No. 15/809,859, filed on Nov. 10, 2017, which is a continuation of U.S. patent application Ser. No. 15/392,303, filed on Dec. 28, 2016, which is a continuation of U.S. patent application Ser. No. 15/095,711, filed on Apr. 11, 2016, which claims the benefit of and priority to U.S. Provisional Patent Application Ser. No. 62/145,064, filed on Apr. 9, 2015, the entireties of which are hereby incorporated herein by reference.

### BACKGROUND

### Field of the Invention

This disclosure relates to protective cases for portable electronic devices, in particular cases which have a built-in stand to support the device.

### Description of the Related Art

Portable electronic devices, such as smartphones, tablets, laptops, and the like are known to sustain damage from impact and from contamination as a result of the ingress of water or other fluids. Such damage may result, for example, in a cracked screen, scratches on a finished surface, lost or damaged buttons or controls, cracked or bent external body components, and/or failed or malfunctioning electrical components. Protective cases can protect portable electronic devices from such damage and other types of damage.

Some of these protective cases have built-in stands that allow the portable electronic device to be supported at an angle on a flat surface. Typically, these stands have foldout legs that support the device. When pressure is applied to a case of this type with the stand legs extended, the legs are prone to breakage. This will destroy the functionality of the case.

Thus, there remains a need for an improved protective device case with an incorporated stand that is not prone to breakage during ordinary use.

### SUMMARY

A case for a portable electronic device that includes a case housing that encloses the portable electronic device and a device stand attached to a back surface of the case housing is disclosed herein. The device stand is formed by an inner stand and an outer stand connected by releasable hinged connections to the back surface of the case housing. One or more tracks may preferably be formed on an inner surface of the outer stand. The inner stand may be configured to slide along the one or more tracks. A locking portion such as a cavity or channel on the outer stand may be configured to lock the inner stand into an open position with respect to the outer stand. At least a portion of the outer stand is flexible such that applying a threshold pressure to the case causes the portion of the outer stand to flex, releasing the inner stand from the locking portion to allow the inner and outer stands to be closed.

The releasable hinged connections may preferably allow the inner and outer stands to separate from the case without breaking. The inner stand is preferably connected to the back surface of the case by hinge protrusions on the inner stand that are inserted into hinge holes in the back surface of the case such that the inner stand can separate from the case without breaking. The outer stand is most preferably connected to the back surface of the case by compressible protrusions that engage hinge slots on the back surface of the case such that the outer stand can separate from the case without breaking. A track may be formed on a surface of the outer stand and the inner stand may be configured to slide along the track. A locking portion on the outer stand is configured to lock the inner stand into an open position with respect to the outer stand. In some embodiments, the locking portion may be a channel into which a portion of the inner stand rests or may be bumps on a surface of the outer stand that form a cavity into which a portion of the inner stand rests. At least a portion of the outer stand is flexible such that applying a threshold pressure to the case causes the portion of the outer stand to flex such that the locking portion releases the inner stand and the outer stand from the open position. The outer stand may have slots which allow a portion of the outer stand to flex and release the inner stand and the outer stand from the open position.

Each of the foregoing and various aspects, together with those set forth in the claims and summarized above or otherwise disclosed herein, including the figures, may be combined without limitation to form claims for a device, apparatus, system, method of manufacture, and/or method of use.

### BRIEF DESCRIPTION OF THE DRAWINGS

The figures provided herewith are intended to illustrate but not to limit the invention.

FIG. 1 shows a back view of an embodiment of the disclosed protective device case with the stand locked in the open position.

FIG. 2 shows a back view of the embodiment shown in FIG. 1 with the stand closed.

FIG. 3 shows a cross sectional side view of the embodiment shown in FIG. 1.

FIG. 4 shows a close up view of the inner and outer stand of the embodiment shown in FIG. 1.

FIGS. 5A-5D show releasable friction fit hinges of an embodiment of the disclosed protective device case.

### DETAILED DESCRIPTION OF THE ILLUSTRATED EMBODIMENTS

A case for a portable electronic device that includes a case housing that encloses the portable electronic device and a device stand attached to a back surface of the case housing is disclosed herein. The device stand is formed by an inner stand and an outer stand connected by releasable hinged connections to the back surface of the case housing. One or more tracks may preferably be formed on an inner surface of the outer stand. The inner stand may be configured to slide along the one or more tracks. A locking portion such as a cavity or channel on the outer stand may be configured to lock the inner stand into an open position with respect to the outer stand. At least a portion of the outer stand is flexible such that applying a threshold pressure to the case causes the portion of the outer stand to flex, releasing the inner stand from the locking portion to allow the inner and outer stands to be closed.

The releasable hinged connections may preferably allow the inner and outer stands to separate from the case without breaking. The inner stand is preferably connected to the back surface of the case by hinge protrusions on the inner stand that are inserted into hinge holes in the back surface of the case such that the inner stand can separate from the case without breaking. The outer stand is most preferably connected to the back surface of the case by compressible protrusions that engage hinge slots on the back surface of the case such that the outer stand can separate from the case without breaking. A track may be formed on a surface of the outer stand and the inner stand may be configured to slide along the track. A locking portion on the outer stand is configured to lock the inner stand into an open position with respect to the outer stand. In some embodiments, the locking portion may be a channel into which a portion of the inner stand rests or may be bumps on a surface of the outer stand that form a cavity into which a portion of the inner stand rests. At least a portion of the outer stand is flexible such that applying a threshold pressure to the case causes the portion of the outer stand to flex such that the locking portion releases the inner stand and the outer stand from the open position. The outer stand may have slots which allow a portion of the outer stand to flex and release the inner stand and the outer stand from the open position.

The disclosed features for locking and unlocking the stand provide a fail-safe that allows the locked stand to disengage under a threshold amount of pressure such that the components of the stand are not readily susceptible to breakage when excessive pressure is applied and the components may easily be reassembled after application of pressure thereto.

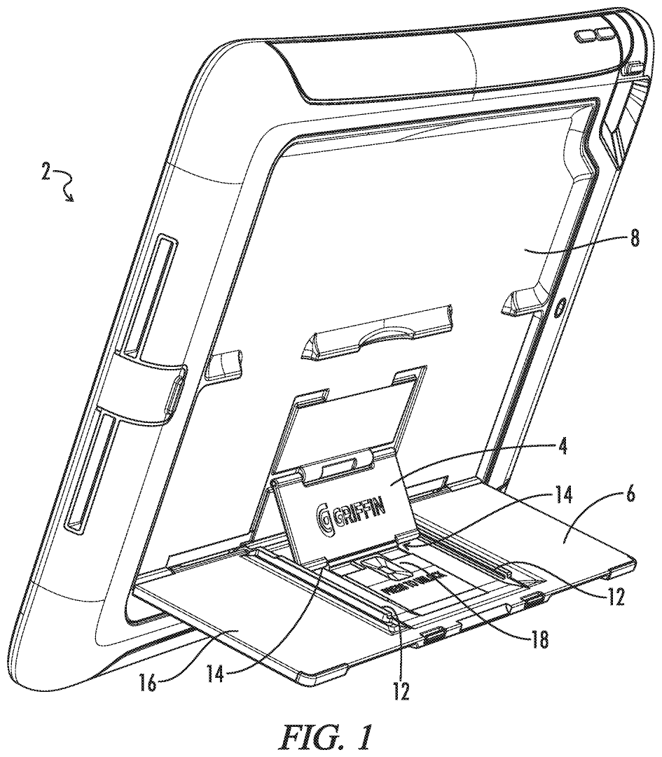

FIG. 1 shows a back view of an embodiment of the disclosed protective device case 2 with the stand locked in the open position. The case 2 includes an inner stand 4 and an outer stand 6 which are hinged to a back surface 8 of the case 2 that encloses a portable electronic device. The inner stand 4 slides along tracks 12 formed on an inside surface 16 of the outer stand 6, allowing the inner stand 4 and outer stand 6 to alternate between a closed position and an open position.

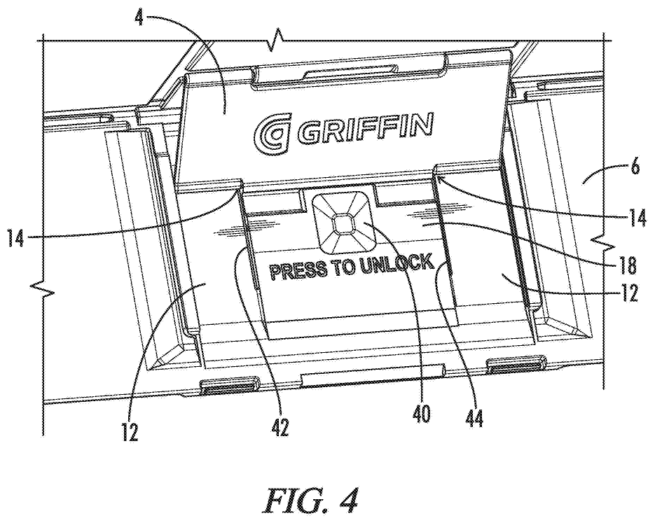

In the open position, the inner stand 4 rests in channels 14 on the inside surface 16 of the outer stand 6 which lock the inner stand 4 in place during use. When a threshold amount of force is exerted on a locking portion 18 or the case 2 itself, two slots 42 and 44, discussed and illustrated in more detail below in connection with FIG. 4, formed in the outer stand 6 allow the locking portion 18 to flex downward, thereby releasing the inner stand 4 from the channels 14 and closing the stand before the exerted pressure induces an amount of stress in the structure of the stand that would cause cracking or breakage.

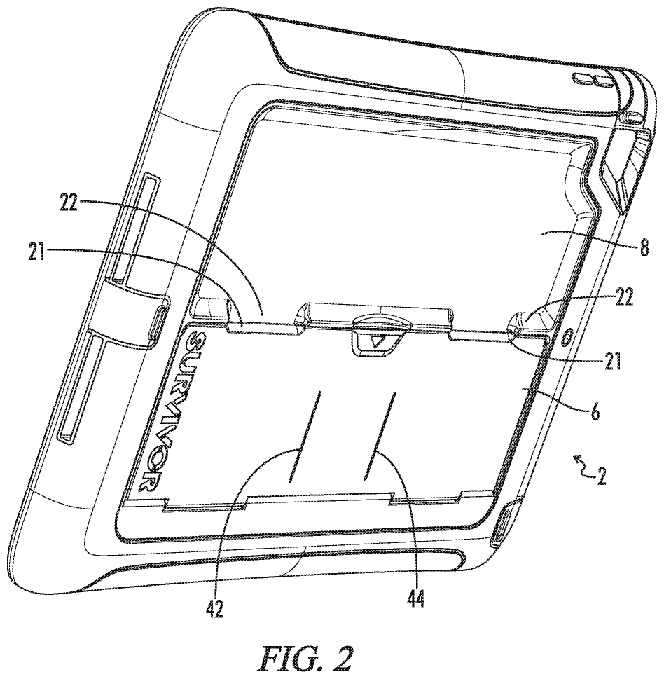

FIG. 2 shows a back view of the embodiment of the protective device case 2 shown in FIG. 1 with the stand closed. To close the stand, a user simply applies a threshold pressure to the case 2 to cause the stand to automatically collapse and release from the open position. The inner stand 4 folds under the outer stand 6. Connectors 21 on the edge of the outer stand 6 snap onto projections 22 on the back surface 8 of the case 2 such that both the inner stand 4 and the outer stand 6 are secured against the back surface 8 of the case 2 when in the closed position.

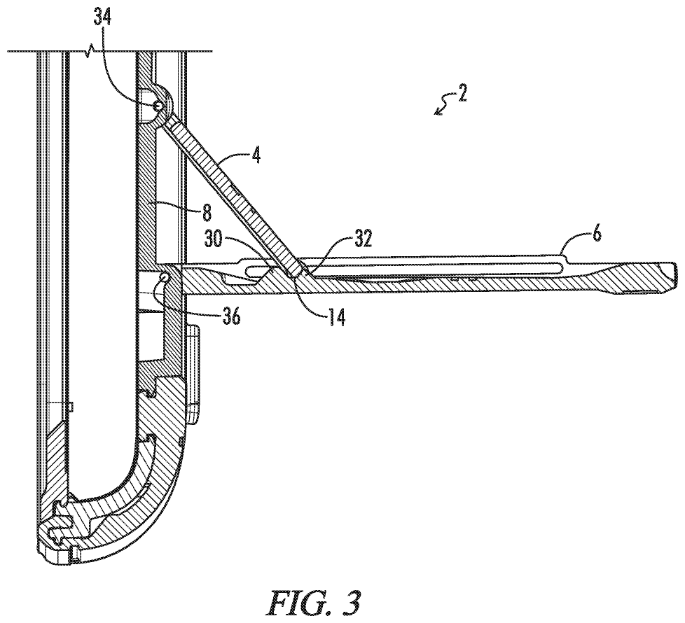

FIG. 3 shows a cross sectional side view of the embodiment of the protective device case shown in FIG. 1. The outer stand 6 has bumps 30 and 32 that form a channel 14 that the edge of the inner stand 4 rests in when the stand is in the open position. The bumps 30 and 32 lock the inner stand 4 into a fixed position with respect to the outer stand 6. The inner stand 4 and outer stand 6 are connected to the back surface 8 of the case 2 with hinged connections 34 and 36 that allow the both the inner stand 4 and the outer stand 6 to pivot about the connections 34 and 36.

FIG. 4 shows a close up view of the inner stand 4 and outer stand 6 of the protective device case 2 shown in FIG. 1. An unlock button 40 is formed on the surface of outer stand 4. Slots 42 and 44 are formed in the outer stand 6 which allow the locking portion 18 to flex downward and release the inner stand 4 from the channels 14 formed in the inside surface of the outer stand 6 and thereby disengage the stand from the open position. The inner stand 4 then slides along the tracks 12 on the inside surface of the outer stand 6, allowing the inner stand 4 and outer stand 6 to close.

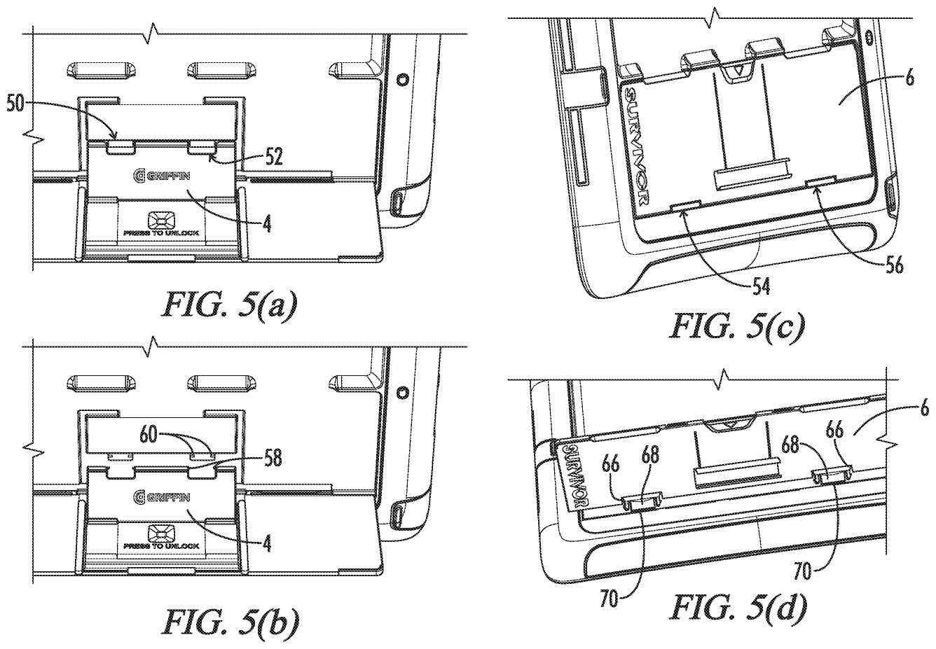

FIGS. 5A-5D are illustrations of preferred releasable friction fit hinges of an embodiment of the disclosed protective device case. Both the hinges 50 and 52 of the inner stand 4 and the hinges 54 and 56 of the outer stand 6 are friction fit connections that are designed to release from the case when a threshold level of force is applied to the hinges. The breakaway friction fit hinges 50, 52, 54, and 56 prevent forces applied from the side, which do not force the inner stand out of the locking channels, from causing the structure of the inner stand 4 or outer stand 6 to break.

FIG. 5A shows the friction fit hinges 50 and 52 of the inner stand 4 connected to the back surface of the case. FIG. 5B shows the friction fit hinges 50 and 52 of the inner stand 4 disengaged from the back surface of the case. The inner stand hinges consist of hinge protrusions 58 on the inner stand 4 that fit in hinge holes 60 on the back surface of the case. The inner stand 4 is constructed from a flexible plastic such that, when pressure is applied, the hinge protrusions 58 disengage from the hinge holes 60 and release the inner stand 4 from the case. This disengagement of the hinge protrusions 58 from the hinge holes 60 occurs even if the pressure applied includes twisting. Once removed, the inner stand 4 may be simply snapped back onto the case by pushing the hinged protrusions 58 back into the hinge holes 60 by flexing the edges of the flexible inner stand.

FIG. 5C shows the friction fit hinges 54 and 56 of the outer stand 6 connected to the back surface of the case. FIG. 5D shows the friction fit hinges 54 and 56 of the outer stand 6 disengaged from the back surface of the case. The outer stand hinges 54 and 56 consist of hinge pins 66 attached to compressible protrusions 68 that fit in securely into hinge slots 70 in the back surface of the case. The compressible protrusions 68 friction fit into the hinge slots 70 is such that, when a threshold pressure is applied, the compressible protrusions 68 disengage from the hinge slots 70 and release the outer stand 6 from the case. This disengagement of the compressible protrusions 68 from the hinge slots 70 occurs even if the pressure applied includes twisting. Once removed, the compressible protrusions 68 may simply be pressed back into the hinge slots 70 to reengage the outer stand 6 to the back surface of the case.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A protective case configured to reversibly receive a portable electronic device, the case comprising:
a case housing having a back surface, the back surface having hinge holes and hinge slots;
an inner stand connected to the back surface by a first hinged connection;
an outer stand connected to the back surface by a second hinged connection; and
a locking portion formed on the outer stand that locks the inner stand into an open position with respect to the outer stand;
wherein at least a portion of the outer stand is flexible, such that applying a threshold pressure to the case causes the flexible portion to flex such that the locking portion releases the inner stand and the outer stand from the open position,
wherein the first hinged connection comprises hinge protrusions on the inner stand that are inserted into the hinge holes on the back surface of the case housing such that the inner stand can separate from the case without breaking, and
wherein the second hinged connection comprises compressible protrusions that engage the hinge slots on the back surface of the case housing such that the outer stand can separate from the case without breaking.

2. The protective case of claim 1 further comprising slots in the outer stand that allow a portion of the outer stand to flex and release the inner stand and the outer stand from the open position.

3. The protective case of claim 1, wherein the locking portion further comprises a channel into which a portion of the inner stand rests.

4. The protective case of claim 1, wherein the first hinged connection is a releasable hinged connection such that the inner stand can separate from the device case without breaking.

5. The protective case of claim 1, wherein the second hinged connection is a releasable hinged connection such that the outer stand can separate from the device case without breaking.

6. The protective case of claim 2, wherein the locking portion further comprises a channel into which a portion of the inner stand rests.

7. The protective case of claim 2, wherein the first hinged connection is a releasable hinged connection such that the inner stand can separate from the device case without breaking.

8. The protective case of claim 2, wherein the second hinged connection is a releasable hinged connection such that the outer stand can separate from the device case without breaking.

9. The protective case of claim 3, wherein the first hinged connection is a releasable hinged connection such that the inner stand can separate from the device case without breaking.

10. The protective case of claim 3, wherein the second hinged connection is a releasable hinged connection such that the outer stand can separate from the device case without breaking.

11. The protective case of claim 4, wherein the second hinged connection is a releasable hinged connection such that the outer stand can separate from the device case without breaking.

12. The protective case of claim 9, wherein the second hinged connection is a releasable hinged connection such that the outer stand can separate from the device case without breaking.

13. The protective case of claim 6, wherein the first hinged connection is a releasable hinged connection such that the inner stand can separate from the device case without breaking.

14. The protective case of claim 6, wherein the second hinged connection is a releasable hinged connection such that the outer stand can separate from the device case without breaking.

15. The protective case of claim 13, wherein the second hinged connection is a releasable hinged connection such that the outer stand can separate from the device case without breaking.
